(19) United States
(12) Patent Application Publication
(10) Pub. No.: US 2009/0138821 A1
(43) Pub. Date: May 28, 2009

(54) Display control apparatus and display control method

(75) Inventors: Kiichiro Shinokura, Tokyo (JP); Kazushi Tahara, Tokyo (JP)

Correspondence Address: YOUNG & THOMPSON, 209 Madison Street, Suite 500, ALEXANDRIA, VA, 22314, US

(73) Assignee: PIONEER CORPORATION, TOKYO (JP)

(21) Appl. No.: 11/920,648

(22) PCT Filed: May 17, 2006
(86) PCT No.: PCT/JP2006/309836

§ 371 Date: Dec. 26, 2007

(30) Foreign Application Priority Data
May 19, 2005 (JP) 2005-146655

(51) Int. Cl. G06F 3/048

(52) U.S. Cl. 715/810

(57) ABSTRACT

A CPU (111) in a video reproducing device (100) permits a display section (320) of a television device (300) to display a menu screen (500) for operating functions of the video reproducing device (100) and the television device (300). The menu screen (500) is displayed as a part of a menu area (400). The menu area (400) is a single flat plane having no hierarchical structure, and various icon groups relating to categories to be included in the menu screen (500) are arranged in the menu area (400) by category.

### TECHNICAL FIELD

The present invention relates to a display control apparatus and method for performing a function operation on a screen on a television apparatus, a recording/reproducing apparatus, or the like.

### BACKGROUND ART

In order to perform this type of function operation, there has been proposed a system having a logically flat navigator structure, for example (e.g. refer to a patent document 1).

According to an interactive program guide navigator menu system (hereinafter referred to as a “conventional technology”) disclosed in the patent document 1, the navigator structure has many selectable program guide categories, and each of the selectable program guide categories corresponds to a relatively large range of program guide service. Therefore, it is considered that all of the usable characteristics of the interactive television program guide can be organized by using just a few program categories.

Patent document 1: Japanese Patent Publication of translated version NO.

### DISCLOSURE OF INVENTION

### Subject to be Solved by the Invention

In the conventional technology, the navigator structure is constructed to be logically flat; however, in order that a user obtains an intended function, the user ends up needing to recall the function from one program guide category or a program guide option which belongs to the program guide category, and sequentially follow a hierarchy. This is inefficient, and according to circumstances, the user may not be able to find the intended function. That is, the conventional technology has such a technical problem that it is hard for the user to perform the function operation, certainly and efficiently, on the screen.

In view of the aforementioned problem, it is therefore an object of the present invention to provide a display control apparatus and method which allows the function operation to be performed, certainly and efficiently, on the screen.

### Means for Solving the Subject

<Display Control Apparatus>

The above object of the present invention can be achieved by a display control apparatus provided with: an arranging device for arranging selectable visual information about categories to be included in a menu screen, in a menu area, which is a single plane, in each of the categories; and a controlling device for controlling a displaying device to display at least one portion of the menu area as the menu screen, in accordance with an entry which indicates that a portion to be displayed as the menu screen is specified in the menu area with the visual information arranged.

According to the display control apparatus of the present invention, in its operation, the visual information about the categories to be included in the menu screen is arranged by the arranging device in the menu area, which is the single plane, in each of the categories.

The “menu screen” in the present invention is a screen for controlling the function of controlled equipment. The controlled equipment conceptually includes equipment in which it is appropriate to at least partially control its function through the menu screen. For example, the controlled equipment may be a television apparatus, a recording/reproducing apparatus which uses a VTR (Video Tape Recorder), a DVD, a HDD, or the like as a recording medium, a FAX apparatus, a phone, and the like.

Incidentally, the number of the controlled equipment, which is a target of the menu screen, is not limited at all. For example, it is appropriate to use the recording/reproducing apparatus in combination with the television apparatus, and in this case, one portion of the function of the television apparatus (e.g. program watching or the like) can be controlled on the recording/reproducing apparatus side. Thus, if the television apparatus is connected to the recording/reproducing apparatus, the menu screen may be a screen for controlling the functions of the two types of apparatuses.

Moreover, the “categories to be included in the menu screen” conceptually include categories which are judged in advance that it is more reasonable to be selected on the menu screen. For example, if the television apparatus and the recording/reproducing apparatus described above are exemplified, the categories include a channel list, a program table, program recording, program recording reservation or reproduction of the recorded program, and the like. The “selectable visual information” about the categories indicates information which can be selected by a user on the menu screen through some input equipment or through some action, such as directly touching the screen. For example, it indicates an icon, a software button, a knob, a lever, or the like. Incidentally, whether or not to be the categories to be included in the menu screen may be determined in advance or arbitrarily. Incidentally, “to select” in the present invention conceptually indicates to perform an operation for performing a function which is assigned to the visual information.

The “menu area” in the present invention is the single plane, and it is an area for arranging the visual information. The “single plane” conceptually indicates a flat surface which does not have a hierarchy structure visually, i.e. which has a single layer structure. The visual information is arranged in the menu area in each category. Incidentally, the menu area is an area of the type that its size is arbitrarily defined in accordance with the number and the size of the visual information to be arranged. It is an area which can be relatively increased as the controlled equipment has more functions.

If the visual information is arranged in the menu area, the controlling device controls the displaying device to display at least one portion of the menu area as the menu screen, in accordance with the entry which indicates that the portion to be displayed as the menu screen is specified in the menu area with the visual information arranged.

Here, the “entry which indicates that the portion to be displayed as the menu screen is specified” is a defined concept including an operation of declaring the user's intent, which is artificially performed through a physical or mechanical inputting device, such as a mouse, a keyboard, a dial, a touch pad, a button switch, and a scroll button, or through an action, such as directly touching the screen. Such an inputting device may be provided with a remote controller terminal (hereinafter referred to as a “remote controller”, as occasion demands).

Moreover, the entry includes not only an entry which is inputted by the user's operation but also an entry which is inputted from another controller and apparatus when some condition is satisfied. That is, the entry may be inputted without the user's external operation. For example, the controlling device may be constructed in advance such that a predetermined portion of the menu area is displayed as the menu screen when the power of the controlled equipment is turned on.

The “displaying device” herein can employ various aspects, such as a plasma display apparatus, a liquid crystal display apparatus, and a CRT (Cathode Ray Tube) display apparatus, in accordance with the aspect of the controlled equipment. Moreover, if the controlled equipment is unified with some display apparatus in advance, such as the television apparatus, the displaying device of the present invention may be such a display apparatus. That is, the displaying device of the present invention may display the menu screen for operating the function of the displaying device of the present invention.

Incidentally, the size of the visual information in the menu area may be appropriately determined in each time, in view of the type of the displaying device, resolution, the size of the display area, and the like. Moreover, the display control apparatus may be constructed such that the user can input the size of the visual information through some inputting device. Moreover, there is no limitation on the position and the size occupied by the menu screen with respect to the display area of the displaying device. That is, the menu screen is not necessarily displayed throughout the entire display area of the displaying device. For example, the menu screen may be displayed so as not to interfere with a screen to be originally displayed on the displaying device (e.g. a television program which is being watched) or the like, in the upper left corner or the like of the display area of the displaying device. Alternatively, if an appropriate display aspect can be determined in advance experimentally, experientially, or by simulations or the like, the menu screen may have the display aspect determined in that manner. Moreover, the position and the size of the menu screen may be changed, as occasion demands, during the display of the menu screen.

As described above, according to the display control apparatus of the present invention, all the visual information to be included in the menu screen is visually arranged in the menu area having the single layer structure, and the menu screen is displayed as at least one portion of the menu area. Therefore, in the process that the intended visual information is selected, it is not necessary to predict and follow the hierarchy structure. For example, only by scroll-displaying the menu screen through the inputting device, such as a scroll button, it is possible to reach all the necessary visual information. Moreover, since the visual information is arranged in each category, it is possible to easily search for the position of the desired visual information on the menu area. That is, it is possible to perform the function operation, certainly and efficiently, on the screen.

Incidentally, the visual information to be arranged in the menu area may be updated, as occasion demands. For example, in case of the television apparatus or the like, the broadcast channel that can be watched is changed depending on its installation site, new contracts, or the like. Alternatively, if recording contents are updated on the recording/reproducing apparatus or the like, it is necessary to add the visual information of the contents in the category, such as a user menu. The arranging device may additionally arrange the new visual information in accordance with a change in the state of the controlled equipment side, or it may delete the visual information that becomes unnecessary. Moreover, the controlled equipment can obtain data about a program table, such as EPG (Electronic Program Guide), the visual information about the program table may be updated, as occasion demands, with reference to the data.

Incidentally, the “arranging device” and the “controlling device” may be formed as a one-body control unit. In this case, the control unit may be built in the controlled equipment, i.e. it may be formed as one portion of the controlled equipment.

Incidentally, the menu area does not necessarily display only the visual information. For example, some information which is common in the categories of the visual information (e.g. a frame of the program table, or the like) may be displayed as a background image.

In one aspect of the display control apparatus of the present invention, the arranging device uniformly arranges the visual information in the menu area.

According to this aspect, the visual information is uniformly arranged in the menu area, so that there is no useless area in the menu area. Therefore, it is possible to select the visual information efficiently.

Incidentally, the term “uniformly” indicates not only strictly arranging the visual information at even intervals but also includes arranging the visual information to the extent that there is no blank area in the menu area. In the process that the visual information is uniformly arranged, the arranging device may partially change the size of the visual information, as occasion demands. For example, in the case that the visual information for defining a channel (e.g. a button with the number thereon, or the like) is arranged in line from the left to the right of the menu screen and that single visual information, such as a recording start button, is arranged just below, if the number of the channels that can be watched is increased as described above, the arrangement area of the visual information for defining the channel naturally extends in a lateral direction. At this time, the visual information may be uniformly arranged as a whole by that the recording start button extends in the lateral direction in response to the extension of the arrangement area.

In another aspect of the display control apparatus of the present invention, the arranging device arranges the visual information on the basis of mutual linkage among the visual information.

The visual information arranged in the menu area is arranged in each category in advance; however, a plurality of visual information is sometimes selected as a series of operations in some visual information. For example, it is assumed that the recording of a program is reserved on the recording/reproducing apparatus. The visual information for giving an instruction indicative of the reservation, the visual information for specifying date and time, the visual information for specifying the program, the visual information for selecting a recording mode, and the like can be selected in a chain reaction in a series of operations. In this case, obviously, it is efficient if the visual information is arranged close to each other.

According to this aspect, since the visual information is arranged on the basis of mutual linkage among the visual information, it is possible to perform the function operation more efficiently. Incidentally, the aspect of arranging the visual information “on the basis of mutual linkage” may be determined in advance, experimentally, experientially, or by simulations or the like.

In another aspect of the display control apparatus of the present invention, the arranging device changes an aspect of displaying the visual information in the menu screen on the basis of a size of the menu screen and a density condition of the visual information.

The size of the menu screen is of a type that is changed in accordance with the size of the display area of the displaying device and each user's preference. For example, if the menu screen displays only an extremely small one portion of the menu area with the visual information uniformly arranged, in the category with a small number of visual information, the visual information displayed on the menu screen may be only single visual information. Alternatively, identification information, such as a character and a mark, which indicates the content of the visual information, may be not displayed at all. In this case, the visual information in the relevant category in the menu screen may interfere with the function operation by the user because of lack of information.

According to this aspect, since the arranging device changes the aspect of displaying the visual information in the menu screen on the basis of the size of the menu screen and the density condition of the visual information, it is efficient in the aforementioned case.

The “density condition” is not necessarily defined as a strict numerical value (i.e. quantitatively). It may be defined in a qualitative concept, such as whether the visual information is arranged relatively densely or less densely.

Moreover, “to change the aspect of displaying” conceptually includes a process of somewhat improving the visibility of the visual information with respect to the user, as compared to the case that such a change in the display aspect is not performed at all. As long as this concept is ensured, the aspect is not limited at all. For example, it may be a process of displaying the identification information (e.g. a channel number or the like) about the visual information, which is located in the surroundings of the visual information displayed near the center of the menu area at this time point, in the menu screen as much as possible. Alternatively, it may be a process of changing the shape of the visual information located in the surrounding and displaying it in the menu screen.

Incidentally, the density condition of the visual information varies frequently depending on each category. Thus, if the display aspect is changed and the menu screen is scrolled in that condition, the display of the visual information in the entire menu screen may become off-balance. In case this happens, with regard to the visual information whose display aspect is changed, a compensation process may be performed, such as changing a scroll display speed to ensure the consistency with the surroundings.

According to this aspect, since the aspect of displaying the visual information in the menu screen is changed on the basis of the size of the menu screen and the density condition of the visual information, the visibility for the user is always ensured, and the function operation can be performed efficiently.

In another aspect of the display control apparatus of the present invention, the controlling device controls the displaying device to display the entire menu area as the menu screen or a screen different from the menu screen, in accordance with an entry which indicates that the entire menu area is to be displayed.

On the display control apparatus of the present invention, even if it is tried to display the entire menu area in the display area of the displaying device, because each of the visual information tends to be smaller than a size in which the user can recognize what it is, the menu screen normally displays one portion of the menu area. However, only from the portion displayed in the menu screen, it is sometimes hard to judge what type of visual information is currently displayed in what category. Alternatively, it is possibly sometimes hard to judge a relative positional relationship between the displayed menu screen and the intended visual information. Alternatively, if the controlled equipment does not have many functions, some deterioration of the visibility may cause the entire menu area to be displayed. In that case, it is sometimes better that the entire menu area is displayed, depending on the user.

According to this aspect, in accordance with the entry which indicates that the entire menu area is to be displayed, the entire menu area is displayed on the displaying device. Thus, the user can easily understand the current position on the menu area. At this time, the entire menu area may be displayed by directly reducing the menu area, or an image which represents the entire menu area may be newly generated.

Incidentally, in this case, the entire menu area may be displayed in such a form that the menu screen that has been displayed immediately before is changed, i.e. as the menu screen. Alternatively, the entire menu area may be displayed as the screen different from the menu screen. Moreover, the entry may be inputted, as in the aforementioned entry, artificially through a mouse, a scroll button, a selection button, or the like, or it may be automatically inputted if a predetermined condition is satisfied.

Incidentally, in this aspect, it may be further provided with a position information generating device for generating position information which indicates a position of the menu screen in the menu area, the controlling device controlling the displaying device to display the position information in association with the entire menu area.

In this case, since the position information, which indicates the position of the menu screen, is displayed in association with the entire menu area, it is possible to perform the function operation more efficiently.

Incidentally, the aspect of the position information is not limited at all, as long as it can indicate the position of the menu screen. For example, it may be text information which simply indicates location, or a rectangular frame or the like. Alternatively, it may be a pointer, such as an arrow and a point. In this case, the pointer may be blinked. Moreover, the “position information” indicates the position of the menu screen in the menu area; however, it does not necessarily strictly indicate the position in the menu area. That is, if it can be judged in which part of the menu area the portion that is currently displayed as the menu screen is, it may indicates a position simplified to some extent.

In another aspect of the display control apparatus of the present invention, it is further provided with a specifying device for specifying priority of the categories on the basis of selection frequency of the visual information, the arranging device rearranging the visual information in accordance with the specified priority.

Since the visual information about the categories to be included in the menu screen is arranged in the menu area, the visual information which exists in the menu area is potentially selected to some extent. However, in the visual information, highly frequently selected visual information and less frequently selected visual information can be generated.

According to this aspect, since the priority of the categories is specified by the specifying device, and the visual information is rearranged on the basis of the specified priority, it is possible to always superiorly arrange the visual information about the highly frequently selected (or used) category. Therefore, usability can be improved with the course of time to use. Incidentally, the term “superiorly” herein conceptually indicates the position of the menu screen in which the operability belongs to a relatively good category. For example, if the operability improvement is expected in the visual information that is physically superior (in this case, in the upper part of the screen), it may be superior in such a physical meaning. Alternatively, if the relation between the position of the category in the menu area and the operability is clarified or estimated for each user, or in advance experimentally, experientially, or by simulations or the like, it may be superior in such a theoretical meaning.

In another aspect of the display control apparatus of the present invention, the controlling device controls the displaying device to enhance display the visual information specified on the menu screen.

According to this aspect, since the visual information specified at this time point in the menu screen is enhance-displayed, the visibility of the menu screen is improved, and it is possible to perform the function operation more efficiently.

The term “specified” herein conceptually indicates the situation that the visual information is indicated by a cursor, a pointer, or the like for simply displaying the user's instruction position on the menu screen, regardless of whether or not the function assigned to the visual information is performed.

Incidentally, the aspect of the emphasis-display is not limited at all; for example, a display color of the specified visual information may be changed, or the visual information itself may be enlarged. Alternatively, the specified visual information may be blinked.

In another aspect of the display control apparatus of the present invention, it is further provided with a supplementary information generating device for generating supplementary information about the visual information, the controlling device controlling the displaying device to display the supplementary information corresponding to the visual information specified on the menu screen.

In the display control apparatus of the present invention, it is efficient because all the visual information about the categories to be selected on the menu screen is arranged in the menu area which is one plane. However, some user requires the supplementary information about individual visual information.

According to this aspect, the supplementary information about the visual information is generated by the supplementary information generating device, and the controlling device controls the displaying device to display the supplementary information corresponding to the visual information currently specified on the menu screen. Thus, it is possible to realize the function operation more efficiently.

Such supplementary information is information for supplementing the visual information. For example, if visual information of “1” is specified to select a television broadcast channel, information which indicates a broadcast station, such as “◯◯ broadcast”, may be displayed as the supplementary information. Moreover, the supplementary information may be assist information which explains an operation for performing the function assigned to the specified visual information. Alternatively, it may be information which indicates what type of visual information exists in the vicinity of the specified visual information. That is, not only the information about the specified visual information itself but also the information related to the relative positional relationship in the menu area (or screen) are also in the range of the supplementary information in the present invention.

<Display Control Method>

The above object of the present invention can be achieved by a display control method provided with: an arranging process of arranging selectable visual information about categories to be included in a menu screen, in a menu area, which is a single plane, in each of the categories; and a controlling process of controlling a displaying device to display at least one portion of the menu area as the menu screen, in accordance with an entry which indicates that a portion to be displayed as the menu screen is specified in the menu area with the visual information arranged.

According to the display control method of the present invention, in its operation, it is possible to realize the aforementioned display control apparatus of the present invention by virtue of each process corresponding to each device of the aforementioned display control apparatus of the present invention.

As explained above, the display control apparatus of the present invention can perform the function operation certainly and efficiently on the screen because it is provided with the arranging device and the controlling device. The display control method of the present invention can perform the function operation certainly and efficiently on the screen because it is provided with the arranging process and the controlling process.

These effects and other advantages of the present invention will become more apparent from the embodiment explained below.

### BRIEF DESCRIPTION OF DRAWINGS

FIG. 1 is a conceptual view showing a menu display system in an embodiment of the present invention.

FIG. 2 is a block diagram showing the system in FIG. 1.

FIG. 3 is a conceptual view showing a menu screen in the system in FIG. 1.

FIG. 4 is a schematic diagram showing a menu area in the system in FIG. 1.

FIG. 5 is a schematic diagram showing a menu screen in the system in FIG. 1.

FIG. 6 are other schematic diagrams showing the menu screen in the system in FIG. 1.

FIG. 7 is a schematic diagram showing position information in the system in FIG. 1.

FIG. 8 are schematic diagrams showing a change in an icon display aspect in the system in FIG. 1.

FIG. 9 are schematic diagrams showing a change in an icon display speed in the system in FIG. 1.

### DESCRIPTION OF REFERENCE CODES

10 menu display system
100 recording/reproducing apparatus
110 control device
111 CPU
200 remote controller terminal
220 input device
300 television apparatus
320 display device

### BEST MODE FOR CARRYING OUT THE INVENTION

Hereinafter, the best mode for carrying out the present invention will be explained in each embodiment in order with reference to the drawings.

### Structure of Embodiment

Firstly, with reference to FIG. 1, the structure of a menu display system in an embodiment of the present invention will be explained. FIG. 1 is a conceptual view showing a menu display system 10.

In FIG. 1, the menu display system 10 is provided with: a recording/reproducing apparatus 100; a remote controller terminal 200; and a television apparatus 300. From the remote control terminal 200 to the recording/reproducing apparatus 100, a control signal is transmitted in accordance with a user's operation. In accordance with the control signal, the recording/reproducing apparatus 100 displays a menu screen on a display device 320 described later of the television apparatus 300. The television apparatus 300 and the recording/reproducing apparatus 100 are electrically connected, and the recording/reproducing apparatus 100 is adapted to superior-control the television apparatus 300.

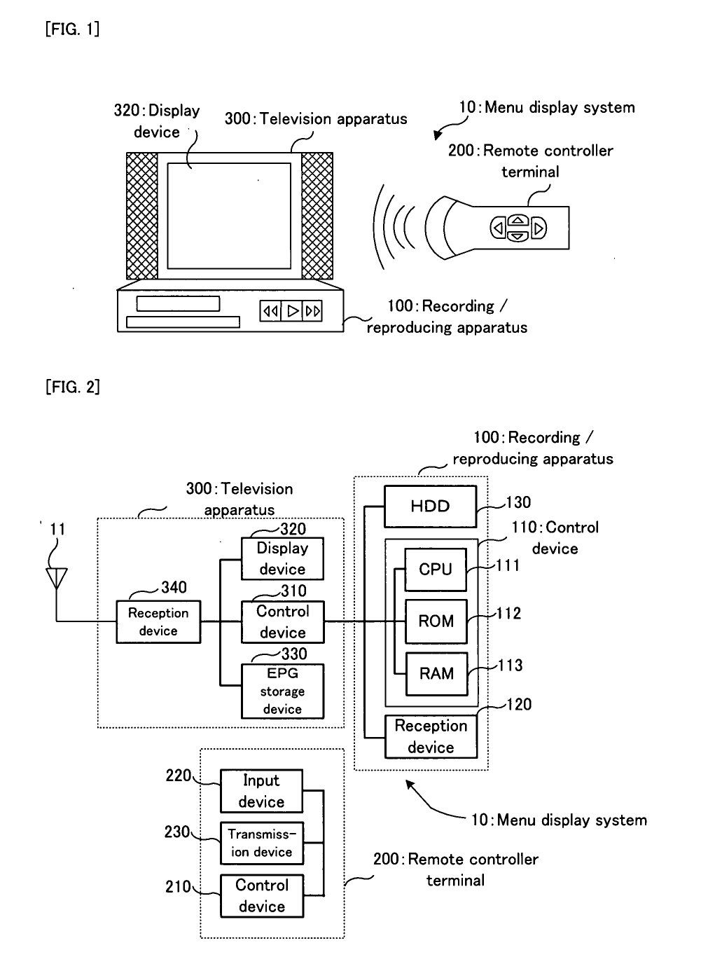

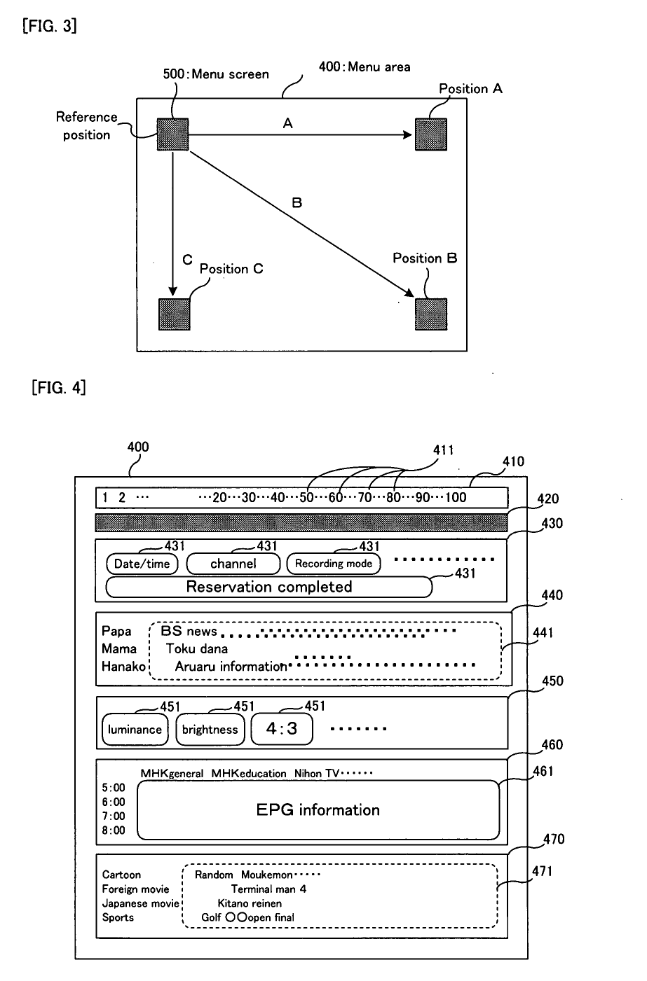

Next, with reference to FIG. 2, the detailed structure of the menu display system 10 will be explained. FIG. 2 is a block diagram showing the menu display system 10. Incidentally, in FIG. 2, the same points as those in FIG. 1 carry the same numerical references, and the explanation thereof will be omitted.

In FIG. 2, the recording/reproducing apparatus 100 is provided with: a control device 110; a reception device 120; and a HDD (Hard Disk Drive) 130.

The control device 110 is provided with: a CPU (Central Processing Unit) 111; a ROM (Read Only Memory) 112; and a RAM (Random Access Memory) 113.

The CPU 111 is a control unit which is adapted to control the operation of the recording/reproducing apparatus 100, and it is one example of the “display control apparatus” of the present invention. The ROM 112 is a nonvolatile memory and stores therein a menu display control program which can be executed by the CPU 111. The RAM 113 is a volatile memory for temporarily storing therein various data which is generated in the process that the CPU 111 executes the menu display program.

The reception device 120 is adapted to receive the control signal transmitted from the remote control terminal 200. The HDD 130 is a recording device for recording various broadcast programs which are received by the television apparatus 300.

The remote control terminal 200 is provided with: a control device 210; an input device 220; and a transmission device 230.

The control device 210 is a control unit for controlling the operation of the remote control terminal 200. The input device 220 is provided with: a scroll button which can be operated in vertical and horizontal directions; and a selective button (both of which are not illustrated), and it is adapted to output an electrical signal according to an operation to the control device 210 when the operation is performed by the user. The transmission device 230 is adapted to transmit the control signal according to the electrical signal outputted from the input device 220, to the recording/reproducing apparatus 100, in accordance with the control of the control device 210.

The television apparatus 300 is provided with: a control device 310; a display device 320; an EPG storage device 330; and a reception device 340.

The control device 310 is a control unit for controlling the operation of the television apparatus 300. In the embodiment, the control device 310 is superior-controlled by the CPU 111 of the recording/reproducing apparatus 100. The display device 320 has a relatively large display area, such as a plasma display panel, and it is adapted to display various broadcast programs and a menu screen described later in accordance with the control of the control device 310. The display device 320 is one example of the “displaying device” of the present invention. The EPG storage device 330 is adapted to store therein EPG information, which is superimposed and transmitted on the various broadcast programs. The reception device 340 is adapted to receive the various broadcast programs in terrestrial broadcasting, satellite broadcasting, or the like, the EGP information, and the like, through an antenna 11.

### Operation of Embodiment

In the menu display system 10 having the aforementioned structure, the CPU 111 of the recording/reproducing apparatus 100 can read the menu display program from the ROM 112 and execute it, to thereby display a menu screen 500 on the display device 320 of the television apparatus 300. The user can control the recording/reproducing apparatus 100 and the television apparatus 300 through the menu screen 500. Now, still with reference to FIG. 2, the operation of the menu display system 10 is explained. Incidentally, it is assumed that the television apparatus 300 and the recording/reproducing apparatus 100 are already powered on.

The CPU 111 firstly requests the EPG information and channel information of television broadcasting, which can be watched at this time point, of the control device 310 of the television apparatus 300. The control device 310 of the television apparatus 300 specifies a channel of the television broadcasting, which can be watched from a broadcast wave received through the antenna 11, in accordance with the request, and it transmits the data which indicates the channel to the recording/reproducing apparatus 100 with the EPG data read from the EPG storage device 330. The CPU 111 stores these transmitted data into the RAM 113. On the other hand, the CPU 111 reads information about a user menu and information about recorded contents or the like and stores them into the RAM 113.

After finishing the accumulation of the various data into the RAM 113, the CPU 111 develops a menu area 400 (not illustrated in FIG. 2) on the RAM 113. Specifically, it generates display data for displaying the menu area 400 on the display device 320. In the menu area, various icons which are generated from the aforementioned information obtained from the television apparatus 300 and the HDD 130, an icon for controlling the function of the recording/reproducing apparatus 100, an icon for controlling the function of the television apparatus 300, and the like are arranged, as occasion demands. Incidentally, the menu area 400 will be described later.

After finishing the development of the menu area 400 on the RAM 113, the CPU 111 waits for an instruction from the remote controller terminal 200. On the remote controller terminal 200, the control device 210 generates a signal for controlling the recording/reproducing apparatus 100 in accordance with the signal inputted through the input device 220, and transmits it through the transmission device 230. On the recording/reproducing apparatus 100, the transmitted signal is received through the reception device 120. The control device 110 generates the display data for displaying one portion of the menu area 400 on the display device 320, on the basis of the received signal, and supplies it to the control device 310. The control device 310 displays the menu screen 500 (not illustrated in FIG. 2) on the display device 320 on the basis of the display data. After that, if some entry is inputted on the remote controller terminal 200, the display data is transmitted to the television apparatus 300, as occasion demands, in accordance with the entry, and a portion of the menu area 400 corresponding to the entry from the remote controller terminal 200 is displayed as the menu screen 500 on the display device 320. After such a process, one portion of the menu area 400 is scroll-displayed, as occasion demands, in one portion of the display area of the display device 320, on the menu screen 500.

Next, with reference to FIG. 3, the outline of the menu screen 500 will be explained. FIG. 3 is a conceptual view showing the menu screen 500.

In FIG. 3, the menu screen 500 can display an arbitrary position on the menu area 400 by that the scroll button and the like, provided for the input device 220 of the remote controller apparatus 200, are operated. For example, if the scroll button is operated to the right (an arrow A direction) at an illustrated reference position, the menu screen 500 is disposed to a position A. Moreover, for example, if the scroll button is operated to the lower right (an arrow B direction), the menu screen 500 is disposed to a position B. Alternatively, if the scroll button is operated in a lower direction (an arrow C direction), the menu screen 500 is disposed to a position C. Incidentally, the reference position is a position set to be immediately disposed by operating a predetermined operation button of the remote controller apparatus 200, regardless of the position of the menu screen at this time point. Normally, it is set in an upper left portion of the menu area 400. Incidentally, the reference position may be set to be changed by operating the remote controller apparatus 200.

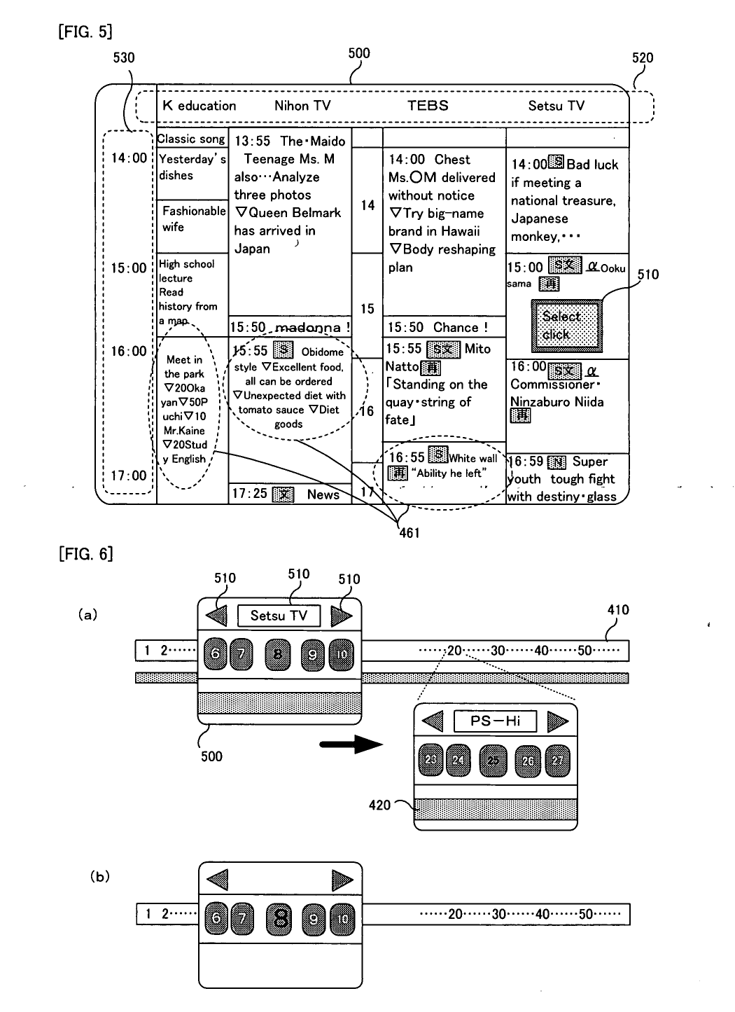

Next, with reference to FIG. 4, the menu area 400 will be explained. FIG. 4 is a conceptual view showing the menu area 400.

In FIG. 4, the menu are 400 is provided with: a channel icon group 410; a recording icon 420; a recording reservation icon group 430; a my-menu icon group 440; a screen adjustment icon group 450; an EPG information icon group 460; and a HDD index 470. Each of them represents one example of the “category” of the present invention.

The channel icon group 410 represents a category for defining channels which can be watched by the television apparatus 300 and has many channel icons 411 arranged. Each channel icon 411 constitutes one example of the “selectable visual information” in the present invention.

The recording icon 420 itself represents a category, and it is another example of the visual information in the present invention. The recording icon 420 is an icon which allows the recording to be started by the recording/reproducing apparatus 100 by being selected on the menu screen 500. Moreover, the recording icon 420 is formed in the same width as that of the channel icon group 410. In the menu area 400, each icon group, the recording icon 420, and the HDD index 470 all have the same width, and icons are uniformly arranged in each of them. Therefore, relatively, the recording icon 420 has a long and thin bar shape. By that each icon is uniformly arranged in the menu area 400, as described above, some icon is definitely displayed on the menu screen 500, so that a highly efficient function operation is realized.

The recording reservation icon group 430 represents a category for defining the recording reservation of a broadcast program by the recording/reproducing apparatus 100, and it has many recording reservation icons 431 arranged. The recording reservation icon 431 is provided with an icon for selecting date and time, an icon for selecting a channel, and the like, and each of them is another example of the visual information in the present invention. Here, in the recording reservation icon group 430, the recording reservation icons 431 are arranged on the basis of mutual linkage among the recording reservation icons. For example, each recording reservation icon is arranged in the linkage order, which is specification of the date and time, specification of the channel, specification of the recording mode, and the icon selected in a chain reaction when the recording is reserved. Therefore, the user can efficiently reserve the recording.

The my-menu icon group 440 represents a category for defining a broadcast program which is frequently watched, and it has many my-menu icons 441 arranged, which is another example of the visual information in the present invention. Moreover, this my-menu icon 441 can be added, as occasion demands, through the input device 220 of the remote controller terminal 200. Incidentally, if a broadcast program is newly registered, The CPU 111 can update the menu area 400 in each time and display the newest menu screen 500 on the display device 320.

The screen adjustment icon group 450 represents a category for defining the adjustment of the display device 320, and it has many screen adjustment icons 451 arranged. Each of the screen adjustment icons 451 is another example of the visual information in the present invention.

The EPG information icon group 460 represents a category for defining a program table, and it has many EPG information icons 461 (omitted in FIG. 4) arranged on the basis of the EPG information supplied from the EPG storage device 330 on the television apparatus 300. Each EPG icon 461 is another example of the visual information in the present invention.

The HDD index 470 represents a category for defining the recording content of the recording/reproducing apparatus 100, and it has many HDD index icons 471 (omitted in FIG. 4) which represent the contents recorded on the HDD 130. The HDD index icon 471 is another example of the visual information in the present invention.

Incidentally, the arrangement of each category can be determined in accordance with the user's preference. For example, by that the user performs the operation related to the user's preference through the remote controller terminal 200, the CPU 111 can update the menu area 400 so as to arrange each category in the order corresponding to the operation. Incidentally, to update the menu area means to change the arrangement aspect of each icon, which is the visual information. Moreover, in the process that the menu screen 500 is continuously used, highly frequently selected icons (or visual information) and less frequently selected icons are generated in the categories included in the menu area 400. In that case, the CPU 111 can specify the priority of each category by storing information which defines the selection frequency in the RAM 113 or the HDD 130 or the like. On the basis of the priority specified as described above, it is possible an easy to determine the arrangement of each category.

Next, with reference to FIG. 5, the details of the menu screen 500 will be explained. FIG. 5 is a schematic diagram showing the menu screen 500. Incidentally, in FIG. 5, the same points as those in FIG. 4 carry the same numerical references, and the explanation thereof will be omitted.

In FIG. 5, the menu screen 500 displays one portion of the EPG information icon group 460 and many EPG information icons 461. Moreover, the menu screen 500 displays a channel bar 520 which indicates the channel information and a time point bar 530 which indicates time point information, in addition to many EPG information icons 461. If the user looks for a desired program on the menu screen 500, the two types of bars are fixed. That is, the CPU 110 always generates the display data such that the channel information and the time point information are displayed if displaying the EPG information icon group 460 on the menu screen 500.

On the other hand, the menu screen 500 displays supplementary information 510. The supplementary information 510 is information for supplementing the function of the EPG information icon 461 specified on the menu screen 500 at this time point. For example, by that “select click” is displayed as illustrated, the user can visually recognize that the function assigned to this icon is realized by a click operation. Incidentally, in this case, by that the user performs the click, one portion of the function of the recording reservation icon 431 in the recording reservation icon group 430 (i.e. the selection of the date and time, the channel, and the like) can be alternated.

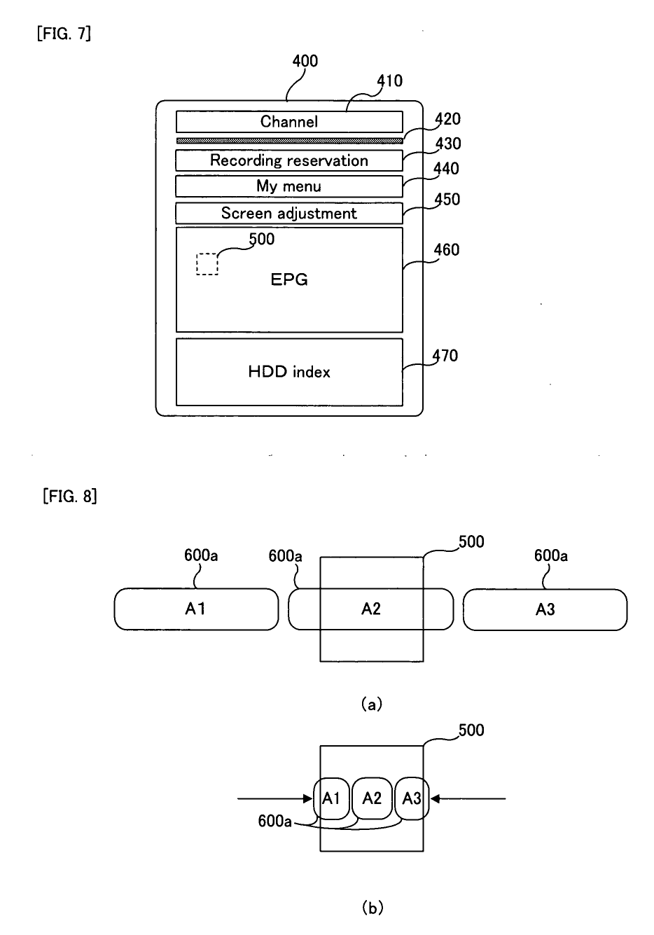

Next, with reference to FIG. 6, another example of the supplementary information will be explained. FIG. 6 are other schematic diagrams showing the menu screen 500. Incidentally, in FIG. 6, the same points as those in FIG. 5 carry the same numerical references, and the explanation thereof will be omitted.

In FIG. 6, the menu screen 500 shows one portion of the channel icon group 410. If a position specified by a pointer, a cursor, of the like at this time point is an icon “8” (one example of the channel icons), a broadcast station name and arrow icons are displayed as the supplementary information 510 (FIG. 6(a)). In this case, the arrow icons indicate that another channel can be selected by going on in an arrow direction, and the broadcast station name indicates the broadcast station corresponding to the specified channel icon. For example, if the display is moved to the right in the drawing in accordance with this arrow, for example, the channel icon becomes “25”, and the broadcast station name is changed. As described above, the supplementary information 510 can improve the operability of the menu screen 500.

Moreover, in addition to the supplementary information, enhance (or emphasis)-displaying the channel icon specified at this time point also allows a further improvement in the visibility and the operability for the user (FIG. 6(b)).

On the other hand, the menu area 400 is a wide area, and in order not to deteriorate the visibility, it is preferable to display one portion thereof on the menu screen 500. However, according to circumstances, it may be not able to judge which portion of the menu area is currently displayed on the menu screen 500. Thus, the CPU 111 is adapted to always display the entire menu area 400 on the display device 320 in accordance with the entry from the remote controller terminal 200 and display information about the position of the menu screen 500. Now, with reference to FIG. 7, such position information is explained. FIG. 7 is a schematic diagram showing the position information.

In FIG. 7, the position of the menu screen 500 with respect to the menu area 400 is shown by a dashed-line frame, as illustrated. By this, the user can immediately recognize that the right edge portion or around that area of the EPG information icon group 460 is currently displayed as the menu screen 500. Incidentally, such position information may be indicated not only by the illustrated dashed-line frame but also as text information which indicates a location, or it may have another display aspect.

As explained above, according to the menu display system 10 in the embodiment, by virtue of the CPU 111, the menu area 400 is formed with the various icons, which are the visual information about the categories to be selected on the menu screen 500, arranged in a single-layer plane in each category, and the menu screen 500 displays at least one portion of the menu area 400. The menu screen 500 can be easily scroll-displayed through the input device 220 provided for the remote controller terminal 200. That is, the various icons arranged in the menu area 400 can be easily selected, which allows the function operation to be performed certainly and efficiently on the screen.

Incidentally, there are various possible aspects in order to improve the operability of the menu screen 500. For example, if a cursor, a pointer, or the like is disposed on the menu screen 500, it is possible to add an acoustic effect and a visual effect. Alternatively, it is also possible to add a tactile effect. Moreover, on the menu screen 500, the visual information (or icon) which cannot be selected currently may be displayed such that the user can visually recognize that it cannot be selected (e.g. in faint color).

Moreover, in the process that the user scroll-operates the menu screen 500, if it further goes beyond the edge portion of the menu area 400, the fact that there is nothing ahead may be displayed, visually, acoustically, or tactilely.

Moreover, the display aspect of the various icons (or visual information) on the menu screen 500 may be changed on the basis of their density condition and the size of the menu screen 500. This will be explained with reference to FIG. 8. FIG. 8 are schematic diagrams showing the change in the icon display aspect.

In FIG. 8, the menu screen 500 displays a category in which icons 600a are arranged in parallel. The density condition of the icons 600a which belong to this category is clearly less dense, with respect to the size of the menu screen 500 (or display area), and the menu screen 500 only displays an icon expressed by identification information (or the item's name) “A2” (FIG. 8(a)). This possibly significantly interferes with the function operation through the menu screen 500.

Thus, the CPU 111 changes the aspect of displaying the icons 600a, on the basis of the density condition of the icons. Specifically, three icons in total, which are the icon expressed by the identification information A2 and adjacent icons which are expressed by identification information A1 and A3, are compressed in arrow directions in FIG. 8, and the display aspect is changed to display these three icons within the menu screen 500 (FIG. 8(b)). By changing the display aspect in this manner, the operability of the menu screen 500 is improved, and the efficient function operation is realized. Incidentally, a method of changing the display aspect is not limited at all and is arbitrarily set as long as it can improve the operability of the menu screen 500 as described above.

Moreover, if the menu screen 500 with such compressed icons displayed is scrolled, for example, step display may be performed which uses one icon as one unit. In this case, there is little chance to display an area in which any icon's identification information is not displayed, like a boundary of the icons, so that it is effective. However, it is not limited to such step display (or digital scroll-display), and analog continuous display may be performed.

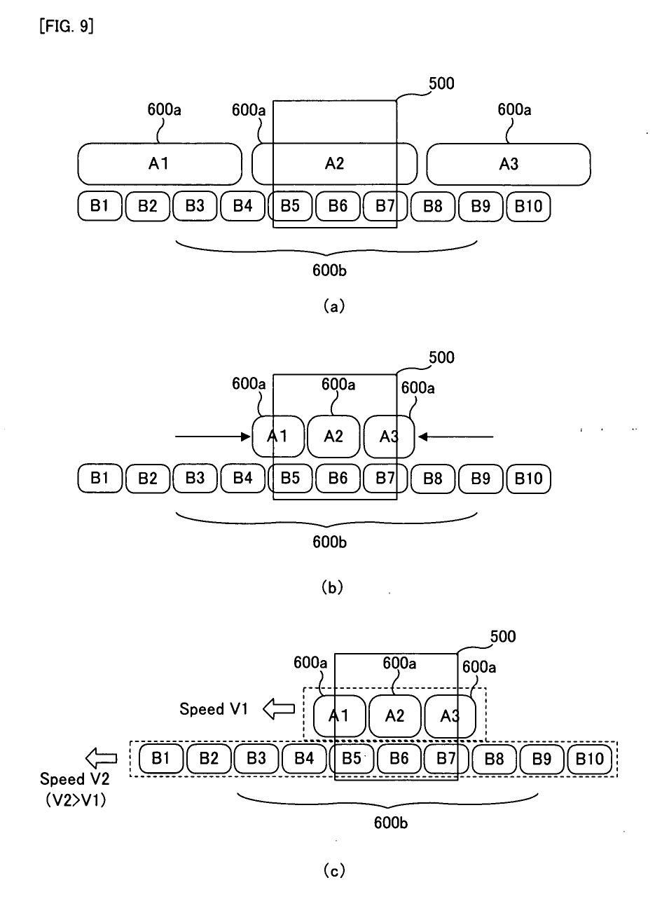

On the other hand, if such compressed icons are scroll-displayed, they are no longer consistent, in a positional relationship, with the icons located above and below the compressed icons (whose categories may be equal or may be different), and the concept of the visual information arrangement based on the linkage may not be able to be ensured. In case this happens, as shown in FIG. 9, a display speed of each visual information may be changed. FIG. 9 are conceptual views showing the icon display speed. Incidentally, in FIG. 9, the same points as those in FIG. 8 carry the same numerical references, and the explanation thereof will be omitted.

In FIG. 9, a plurality of icons 600b are arranged below the icons 600a (FIG. 9(a)). Now, as shown in FIG. 8, if the aspect of displaying the icons 600a is changed (FIG. 9(b)), a relative positional relationship between the icons 600a and the icons 600b disconnects from the original one. For example, if it is tried to scroll-display the menu screen 500 to the right in the drawing in this sate and display the icon 600a, which is expressed by the identification information A3, in the center of the menu screen 500, instead of the icons 600b which are expressed by identification information B8 to B10 and which are originally supposed to be arranged below the icons 600a, an icon expressed by identification information B7 and the like are displayed.

Thus, the CPU 111 individually changes the display speed in the scroll-display if there is the icon whose display aspect is changed within the menu screen 500, to thereby ensure the mutual linkage among the icons. Specifically, if the menu screen 500 is scroll-displayed to the right in the drawing, the display speed is individually set such that the icon 600a is scroll-displayed to the left at a scroll speed V1 and the icon 600b is scroll-displayed to the left at a scroll speed V2 (V2>V1) (FIG. 9(c)). As a result, it is possible to perform the function operation efficiently while ensuring the mutual linkage among the icons in the menu area 400.

Incidentally, in the present invention, various changes may be made without departing from the essence or spirit of the invention which can be read from the claims and the entire specification. A display control apparatus and method, which involve such changes, are also intended to be within the technical scope of the present invention.

### INDUSTRIAL APPLICABILITY

The display control apparatus and the display control method according to the present invention can be applied to a display control apparatus or the like for performing a function operation on a screen on a television apparatus, a recording/reproducing apparatus or the like.

1. A display control apparatus comprising:
an arranging device for arranging selectable visual information about categories to be included in a menu screen, in a menu area, which is a single plane, in each of the categories; and
a controlling device for controlling a displaying device to display at least one portion of the menu area as the menu screen, in accordance with an entry which indicates that a portion to be displayed as the menu screen is specified in the menu area with the visual information arranged.

2. The display control apparatus according to claim 1, wherein said arranging device uniformly arranges the visual information in the menu area.

3. The display control apparatus according to claim 1, wherein said arranging device arranges the visual information on the basis of mutual linkage among the visual information.

4. The display control apparatus according to claim 1, wherein said arranging device changes an aspect of displaying the visual information in the menu screen on the basis of a size of the menu screen and a density condition of the visual information.

5. The display control apparatus according to claim 1, wherein said controlling device controls said displaying device to display the entire menu area as the menu screen or a screen different from the menu screen, in accordance with an entry which indicates that the entire menu area is to be displayed.

6. The display control apparatus according to claim 5, further comprising a position information generating device for generating position information which indicates a position of the menu screen in the menu area,
said controlling device controlling said displaying device to display the position information in association with the entire menu area.

7. The display control apparatus according to claim 1, further comprising a specifying device for specifying priority of the categories on the basis of selection frequency of the visual information,
said arranging device rearranging the visual information in accordance with the specified priority.

8. The display control apparatus according to claim 1, wherein said controlling device controls said displaying device to enhance-display the visual information specified on the menu screen.

9. The display control apparatus according to claim 1, further comprising a supplementary information generating device for generating supplementary information about the visual information,
said controlling device controlling said displaying device to display the supplementary information corresponding to the visual information specified on the menu screen.

10. A display control method comprising:
an arranging process of arranging selectable visual information about categories to be included in a menu screen, in a menu area, which is a single plane, in each of the categories; and
a controlling process of controlling a displaying device to display at least one portion of the menu area as the menu screen, in accordance with an entry which indicates that a portion to be displayed as the menu screen is specified in the menu area with the visual information arranged.
